(19) United States
(12) Patent Application Publication
(10) Pub. No.: US 2025/0252853 A1
(43) Pub. Date: Aug. 7, 2025

(54) AUTOMATED VALET PARKING MANAGEMENT SYSTEM

(71) Applicant: TOYOTA JIDOSHA KABUSHIKI KAISHA, Toyota-shi (JP)

(72) Inventors: Takuya NAKAGAWA, Okazaki-shi (JP); Takahiro YAMAMOTO, Toyota-shi (JP); Tsutomu MOCHIDA, Sunto-gun (JP)

(73) Assignee: TOYOTA JIDOSHA KABUSHIKI KAISHA, Toyota-shi (JP)

(21) Appl. No.: 19/002,101

(22) Filed: Dec. 26, 2024

(30) Foreign Application Priority Data
Feb. 6, 2024 (JP) 2024-016187

(51) Int. Cl. G08G 1/14; G06Q 10/02

(52) U.S. Cl. CPC G08G 1/144; G06Q 10/02; G08G 1/146

(57) ABSTRACT

An automated valet parking management system for managing automated valet parking in a parking lot includes one or more processors. The one or more processors are configured to determine whether the use reservation of the automated valet parking by the vehicle is made when the vehicle compatible with the automated valet parking arrives at the parking lot, search for vacancy information of the reservation of the parking slot of the parking lot when the use reservation has not been made, and notify the user of the usage proposal of the automated valet parking via the terminal device operated by the user of the vehicle when there is free space in the reservation of the parking slot.

### CROSS-REFERENCE TO RELATED APPLICATION

This application claims priority to Japanese Patent Application No. 2024-016187 filed on Feb. 6, 2024, incorporated herein by reference in its entirety.

### BACKGROUND

### 1. Technical Field

The present disclosure relates to technology for managing automated valet parking (AVP) in a parking lot.

### 2. Description of Related Art

Japanese Unexamined Patent Application Publication No. 2020-201666 (JP 2020-201666 A) discloses a parking control device for performing parking control, for parking a vehicle in a reserved parking area which is a parking area regarding which an entry time is reserved. When a vehicle with a reservation arrives at the parking lot earlier than the reserved entry time, the parking control device determines whether the reserved parking area is available for parking. As a result, when the reserved parking area is not available for parking, the parking control device parks the vehicle in a temporary parking area, when the temporary parking area that is different from the reserved parking area is available for parking.

### SUMMARY

Technology described in JP 2020-201666 A is intended for a vehicle that has a reservation, and does not take into consideration a situation in which a vehicle that is compatible with automated valet parking (AVP) arrives at a parking lot that is compatible with AVP, without an AVP usage reservation.

The present disclosure has been made in view of the above-described problem, and an object thereof is to improve convenience for a user of a vehicle that has arrived at a parking lot without reservation for use of automated valet parking.

An automated valet parking management system according to the present disclosure manages automated valet parking in a parking lot.
The automated valet parking management system includes one or more processors.
The one or more processors are configured to
determine, when a vehicle that is compatible with the automated valet parking arrives at the parking lot, whether a usage reservation for the automated valet parking is made by the vehicle,
search for vacancy information for reservation of a parking slot in the parking lot, when no usage reservation is made, and
when the parking slot is vacant with respect to reservation, notify a user of the vehicle regarding a usage proposal of the automated valet parking, via a terminal device operated by the user.

According to the automated valet parking management system of the present disclosure, when the vehicle compatible with AVP arrive at the parking lot without prior reservation regarding the use of AVP, vacancy information for reservation of a parking slot compatible with AVP is voluntarily searched for by the automated valet parking management system. When there is vacancy with respect to reservation, the user is notified of the usage proposal of AVP from the automated valet parking management system, via the terminal device. Accordingly, when the user of the vehicle that has arrived at the parking lot desires to use AVP, the user him/herself does not need to perform reservation operations, including confirmation of the vacancy of the parking slot, in the parking lot. Thus, the convenience of the user of the vehicle that has arrived at the parking lot without reserving the use of AVP is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of an automated valet parking management system according to an embodiment;

FIG. 2 is a flowchart illustrating an example of processing of the automated valet parking management system according to the embodiment;

FIG. 3 is a diagram illustrating an exemplary display of a usage proposal on a display of a HMI mounted on a vehicle;

FIG. 4 is a diagram illustrating a display example of a usage proposal on a screen of a display of a user terminal;

FIG. 5 is a flow chart illustrating another exemplary process of the automated valet parking management system according to the embodiment; and

FIG. 6 is a flowchart illustrating still another example of processing of the automated valet parking management system according to the embodiment.

### DETAILED DESCRIPTION OF EMBODIMENTS

Embodiments of the present disclosure will be described with reference to the accompanying drawings.

### 1. Configuration of Automated Valet Parking Management System

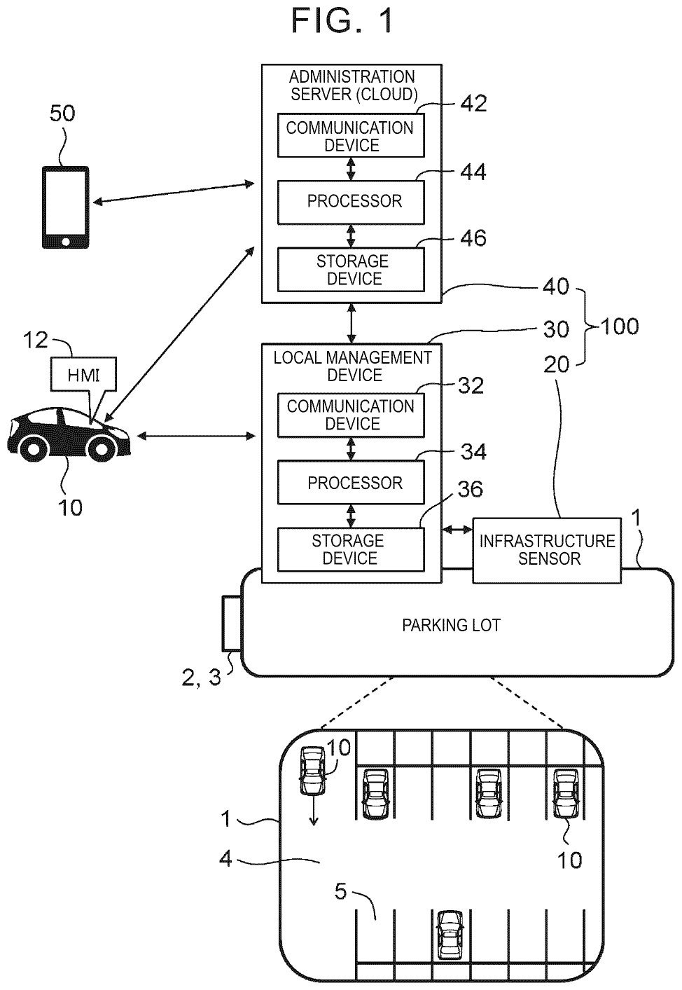

FIG. 1 is a diagram schematically illustrating an example of a configuration of an automated valet parking management system 100 according to an embodiment. The automated valet parking (AVP) manager 100 manages AVP of the vehicles 10 in the parking lot 1.

The vehicle 10 is a vehicle compatible with AVP in the parking lot 1. The vehicle 10 can automatically travel at least in the parking lot 1 regardless of the driving operation by the driver. More specifically, the vehicle 10 includes a recognition sensor (for example, a camera) for recognizing a surrounding situation. The vehicle 10 performs automatic traveling in the parking lot 1 while recognizing the surrounding situation using the recognition sensor. The vehicle 10 may be an autonomous vehicle capable of autonomous traveling outside the parking lot 1. In addition, the vehicle 10 is equipped with a Human Machine Interface (HMI) 12 as an interface with a user (an occupant) of the vehicle 10. HMI 12 is, for example, a touch panel. HMI 12 may include a speaker. HMI 12 corresponds to an exemplary “terminal device” according to the present disclosure.

The parking lot 1 includes a getting-off area 2, a getting-on area 3, a passage 4, and a plurality of parking slots 5. The vehicle 10 entering the parking lot 1 stops in the getting-off area 2, where the user gets off the vehicle 10. On the other hand, the vehicle 10 leaving the parking lot 1 stops in the getting-on area 3, where the user gets in the vehicle 10. The getting-off area 2 may also be referred to as an entry area, and the getting-on area 3 may also be referred to as an exit area. The passage 4 is a region in which the vehicle 10 travels. The parking slot 5 is a space in which the vehicle 10 is parked. For example, the parking slot 5 is divided by a dividing line. Note that the parking lot 1 may be a parking lot dedicated to AVP only for AVP vehicles 10, or may be a parking lot that can use AVP vehicles 10 that do not use AVP function and the vehicles that do not have AVP function.

In the exemplary embodiment illustrated in FIG. 1, AVP management device 100 includes one or more infrastructure sensors 20 (hereinafter, simply referred to as “infrastructure sensors 20”), a local management device 30, and a management server 40. The local management device (or simply “management device”) 30 is provided in the parking lot 1. The management server (cloud) 40 manages a plurality of parking lots 1. In AVP management device 100, various processes described later related to the management of AVP are executed by cooperation of the management device 30 and the cloud 40.

The infrastructure sensor 20 includes, for example, a camera, and recognizes the situation of the parking lot 1. More specifically, the infrastructure sensor 20 recognizes a situation around the vehicle 10 in the parking lot 1 (for example, obstacles such as pedestrians and other vehicles). In addition, the infrastructure sensor 20 recognizes the vacancy of the parking slot 5. The information obtained by the infrastructure sensor 20 is transmitted to the local management device 30. The infrastructure sensor 20 corresponds to an example of a “recognition sensor” according to the present disclosure.

The local management device 30 includes a communication device 32, one or more processors 34 (hereinafter simply referred to as processors 34), and one or more storage devices 36 (hereinafter simply referred to as storage devices 36). The communication device 32 communicates with the vehicle 10 and the management server 40 via a communication network.

The processor 34 executes various processes related to managing AVP. Examples of the processor 34 include CPU, GPU, ASIC, FPGA, and the like. The processor 34 may also be referred to as a circuitry or a processing circuitry. Circuitry is hardware programmed to implement the described functions, or hardware that performs the functions. The storage device 36 stores various types of information. Examples of the storage device 36 include a volatile memory, a nonvolatile memory, and a HDD, SSD. The functions of the management device 30 may be realized by cooperation of the processor 34 executing the first management program and the storage device 36. The first management program is stored in the storage device 36. Alternatively, the first management program may be recorded in a computer-readable recording medium. The first management program may be provided via a network.

The management server (cloud) 40 includes a communication device 42, one or more processors 44 (hereinafter simply referred to as processors 44), and one or more storage devices 46 (hereinafter simply referred to as storage devices 46). The communication device 42 communicates with the vehicle 10, the management device 30, and the user terminal 50 via a communication network. The user terminal 50 is a terminal (for example, a smartphone) possessed by a user of the vehicle 10, and corresponds to another example of the “terminal device” according to the present disclosure.

The processor 44 executes various processes related to managing AVP. Examples of the processor 44 include CPU, GPU, ASIC, FPGA, and the like. The processor 44 may also be referred to as a circuitry or a processing circuitry. Circuitry is hardware programmed to implement the described functions, or hardware that performs the functions. The storage device 46 stores various types of information. Examples of the storage device 46 include a volatile memory, a nonvolatile memory, and a HDD, SSD. The functions of the cloud 40 may be realized by cooperation of the processor 44 executing the second management program and the storage device 46. The second management program is stored in the storage device 46. Alternatively, the second management program may be recorded in a computer-readable recording medium. The second management program may be provided via a network.

For example, AVP management device 100 executes the “various processes related to the management of AVP” in the following manner in cooperation with the management device 30 and the cloud 40.

The cloud 40 manages information (user information) related to users of AVP services. The user information includes member information of each user registered in advance and the next reservation information.

When a user X reserves a AVP, the user X operates the user terminal 50 to enter ID information (identification information) of the user X, a desired parking lot 1, a desired use date, a desired use time (a scheduled entry time and a scheduled entry time), and the like. The user terminal 50 transmits the appointment information including the inputted information to the cloud 40 (AVP management system 100). The storage device 46 of the cloud 40 stores vacancy information of the latest parking slot 5 acquired from the management device 30. The cloud 40 that has received the reservation information from the user X performs the reservation process based on the reservation information when the reservation of the parking slot 5 (more specifically, the parking slot 5 for AVP) of the parking lot 1 is vacant. The reservation process includes assigning an empty parking slot 5 to the vehicle 10, i.e., making a reservation of the parking slot 5 for the vehicle 10. When the reservation process is completed, the cloud 40 transmits a reservation completion notification to the user terminal 50. Note that the “terminal device” used for the reservation described here may be a HMI 12.

When the vehicle 10 carrying the user X arrives in the getting-off area 2 of the parking lot 1, the management device 30 detects the arrival of the vehicle 10 using the infrastructure sensor 20. At this time, the management device 30 performs processing for identifying the arriving vehicle 10. Specifically, the management device 30 recognizes the number of the license plate of the vehicle 10 using, for example, the infrastructure sensor 20. The number of the license plate corresponds to an example of identification information of the vehicle 10. The management device 30 transmits information indicating the arrival of the vehicle 10 to the cloud 40 together with the identification information. The storage device 46 of the cloud 40 stores the identification information of the vehicles 10 using AVP service. For example, the cloud 40 identifies the vehicle 10 that has arrived in the getting-off area 2 by collating the identification information received from the management device 30 with the identification information stored in the storage device 46. Then, the cloud 40 identifies the identified user of the vehicle 10 based on the user information.

Then, the cloud 40 determines whether the arriving vehicle 10 is a vehicle with a AVP use reservation based on the reservation data. In addition, the cloud 40 executes a process of requesting the user X's consent to remotely control the vehicle 10 by AVP control device 100 for parking the vehicle 10 reserved for use of AVP. When the cloud 40 receives information (for example, a request to initiate a AVP) indicating the consent of the user X via the user terminal 50 or HMI 12, the operating authority of the vehicle 10 moves from the user X to AVP management system 100. AVP manager 100 performs an entry process for the vehicles 10.

The entry process includes a process related to parking control of the vehicle for parking the vehicle 10 in the reserved parking slot 5. In the parking control, the management device 30 acquires information indicating a situation around the vehicle 10 in the parking lot 1 (for example, obstacles such as pedestrians and other vehicles) from the infrastructure sensor 20. Then, the management device 30 generates a target travel route from the getting-off area (entry area) 2 to the parking slot 5 assigned to the vehicle 10 based on the information. Then, the management device 30 communicates with the vehicle 10 and remotely controls the vehicle 10 so as to travel in accordance with the generated target travel route. Alternatively, in another example of the parking control, AVP managing device 100 may transmit the information on the target travel route to the vehicle 10 together with the information on the parking slot 5 assigned to the vehicle 10 and the map information on the parking lot 1. The vehicle 10 may automatically travel along the received target travel route using a recognition sensor such as a camera mounted on the vehicle 10.

The management device 30 uses the infrastructure sensor 20 to detect that parking of the vehicle 10 is completed. Alternatively, when the parking is completed, the vehicle 10 may notify the management device 30 of the completion of the parking. After the parking is completed, the management device 30 communicates with the vehicle 10 and stops the operation of the vehicle 10 (power supply OFF). The cloud 40 acquired from the management device 30 the information indicating that the parking of the vehicle 10 is completed holds the information of the parking slot 5 of the vehicle 10 in association with the user X.

The delivery processing of the vehicle 10 from the parking lot 1 is executed, for example, as follows. That is, in response to a retrieval request from the user X who operates the user terminal 50, the cloud 40 executes a process of requesting the user X's consent to remotely operate the vehicle 10 by AVP control system 100 for retrieval of the vehicle 10. When the cloud 40 receives information indicating the consent of the user X via the user terminal 50 (for example, a request for starting the delivery of the vehicle 10), AVP management system 100 communicates with the vehicle 10 and activates the vehicle 10 (power supply ON). Then, in the delivery processing, the management device 30 generates, for example, a target travel route from the parking slot 5 to the getting-on area (delivery area) 3 based on the information from the infrastructure sensor 20 as in the case of the entry processing. Then, for example, the management device 30 communicates with the vehicle and remotely controls the vehicle 10 so as to travel in accordance with the generated target travel route. When the vehicle 10 arrives at the getting-on area 3 and stops, the operating authority of the vehicle 10 moves from AVP control system 100 to the user X. After the passenger including the user X gets into the vehicle 10, the vehicle 10 starts to the next destination.

2. Measures for Vehicles that Arrive without AVP Reservations

In order to use AVP service, a reservation is required in order to secure a parking slot. Therefore, when the vehicles compatible with AVP arrive at the parking lot compatible with AVP without reserving the use of AVP, the following problems arise unless special consideration is given. That is, it is necessary for the user of the arriving vehicle to perform the reservation operation including the confirmation of the vacancy of the parking slot in the getting-off area (entry area) of the parking lot. Consequently, there is a possibility that the user is troubled with the use of AVP. Also, congestion in the getting-off area may be caused. Further, the parking lot where the user arrives may be capable of both parking using a AVP and parking by driving the user. In such cases, even if the user intends to use AVP service, the user may not notice that the user can use AVP and park by driving himself/herself.

Therefore, when the vehicle 10 compatible with AVP arrives at the getting-off area 2 of the parking lot 1, AVP control device 100 according to the present embodiment determines whether the use of AVP is reserved by the vehicle 10. When the use reservation has not been made, the cloud 40 searches for vacancy information of the parking slot 5 of the parking lot 1. The parking slot 5 to be searched for the vacancy information is a parking slot that can be used by AVP. When the parking slot 5 is vacant, the cloud 40 notifies the user of the usage proposal of AVP via the “terminal device”. The terminal device used for notification of the usage proposal is at least one of HMI 12 and the user terminal 50.

### 2-1. Example of AVP Administration Process

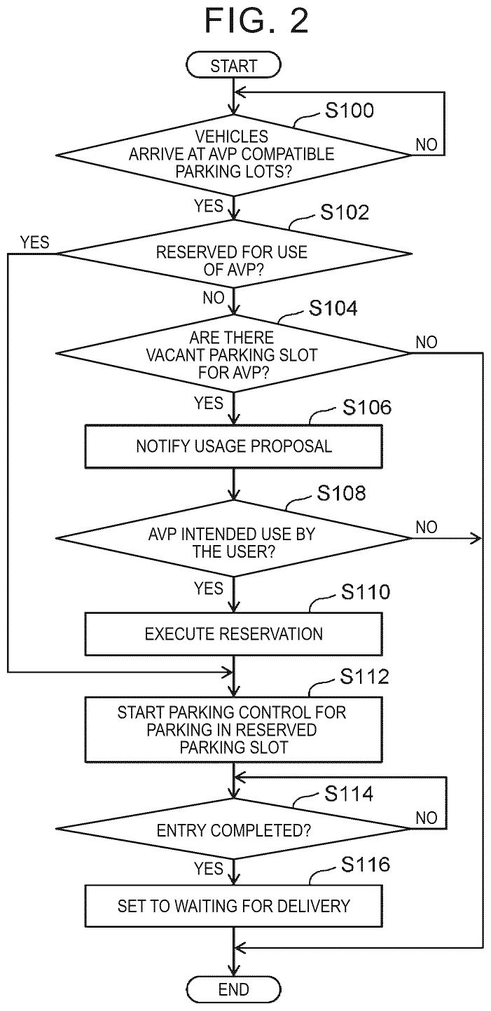

FIG. 2 is a flow chart illustrating an exemplary process of AVP managing device 100 according to the embodiment. This flowchart is executed, for example, by cooperation of the management device 30 and the cloud 40 that communicate with each other.

In S100, the management device 30 (the processor 34) determines whether the vehicle 10 compatible with AVP has arrived at the parking lot 1 compatible with AVP. More specifically, the management device 30 determines whether the vehicle 10 has arrived at the parking lot 1 using, for example, the infrastructure sensor 20. Consequently, when the vehicle 10 arrives at the parking lot 1 (S100: Yes), the process proceeds to S102.

In S102, the cloud 40 (the processor 44) determines whether AVP is reserved for use by the vehicle 10. This determination is performed based on the reservation information stored in the storage device 46. Consequently, if there is a AVP use reservation (S102: Yes), the process proceeds to S112. On the other hand, when there is no AVP use reservation (S102: No), the process proceeds to S104.

In S104, the cloud 40 determines whether there is vacancy space in the reservation of the parking slot 5 for AVP. That is, the cloud 40 voluntarily searches for vacancy space in the parking slot 5 for AVP. This determination (search) is performed based on the vacancy information of the parking slot 5 stored in the storage device 46. Consequently, if there is no vacancy space available for AVP parking slot 5 (S104: No), the process proceeds to END. On the other hand, when there is a vacancy space available for AVP parking slot 5 (S104: Yes), the process proceeds to S106.

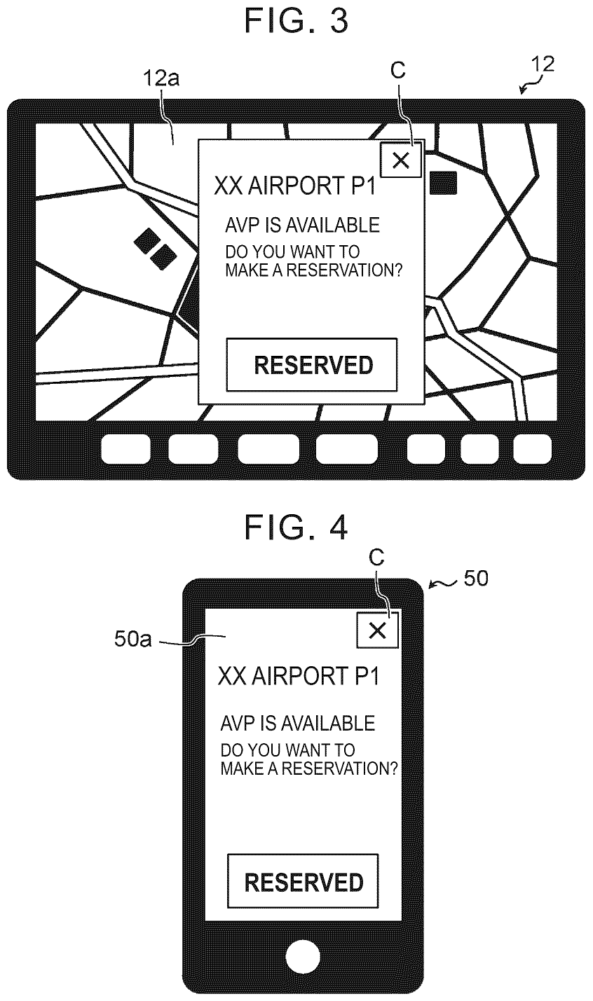

In S106, the cloud 40 notifies the user of the vehicle 10 of the “usage proposal” of AVP. This notification is executed for the “terminal device”, that is, at least one of HMI 12 and the user terminal 50. The notification of the usage proposal is performed by displaying the usage proposal on the display of the terminal device as illustrated with reference to the following FIGS. 3 and 4. Alternatively, the notification of the usage proposal may be made by voice using the speaker of the terminal device instead of or together with the display.

FIG. 3 shows an exemplary display of a usage proposal for a screen 12a of a display of a HMI 12 mounted on the vehicle 10. In this display example, the usage proposal includes a message of “AVP available” as an example of “information indicating that there is a vacancy space in the reservation of the parking slot 5” together with the letter “XX airport P1” as an example of the name of the parking lot 1. Alternatively, the “information indicating that there is a vacancy in the reservation of the parking slot 5” may include, for example, a message “there is a vacancy in the parking slot for AVP”. In addition, in this display example, as an example of “Information for confirming whether or not the user intends to use AVP”, the usage proposal includes a message “Reserved?”, display of “Reservation button”, and a “Close screen button” display C. In addition, instead of the display C of the “close screen button”, for example, the display of the button with the letter “not reserved” may be used. In addition, in the case of usage proposal only by voice, “the information to confirm the intent of the user regarding the use of AVP” may include only the message, for example, “Do you want to reserve it?”.

FIG. 4 shows an exemplary display of the usage proposal for the screen 50a of the display of the user terminal 50. Also in this display example, as in the display example on HMI 12, the usage proposal includes a message of “AVP available” as an example of “information indicating that there is a vacancy in the reservation of the parking slot 5” together with the character “XX airport P1”. Alternatively, the “information indicating that there is a vacancy in the reservation of the parking slot 5” may include, for example, a message “there is a vacancy in the parking slot for AVP”. Also, in this display example, as an example of “information for confirming the intent of the user regarding the use of AVP”, the usage proposal includes a message “Do you want to reserve it?”, display of “Reservation button”, and “Close screen button” display C. In addition, instead of the display C of the “close screen button”, for example, the display of the button with the letter “not reserved” may be used. In addition, in the case of usage proposal only by voice, “the information to confirm the intent of the user regarding the use of AVP” may include only the message, for example, “Do you want to reserve it?”.

In S108 following S106, the cloud 40 determines whether the user of the vehicle 10 intends to use AVP. This determination is made based on the content of the user's reply to the usage proposal. Specifically, for example, when the user operates HMI 12 or the user terminal 50 and touches the “appointment button”, the cloud 40 determines that the user intends to use AVP. Consequently, the process proceeds to S110. On the other hand, for example, when the user operates HMI 12 or the user terminal 50 and touches the “button for closing the screen” or the “button with a letter indicating not to reserve”, the cloud 40 determines that the user does not intend to use AVP. Consequently, the process proceeds to END. In addition, the “terminal device” such as HMI 12 and the user terminal 50 may have a speech recognizing function. Then, the terminal device may accept the user's reply to the usage proposal by using the voice recognition function.

In S110, the cloud 40 executes a process related to the use reservation of AVP. This process involves assigning an empty parking slot 5 for AVP to the vehicle 10, i.e., making a reservation of the parking slot 5 for the vehicle 10. Thereafter, the process proceeds to S112.

In S112, the management device 30 starts the above-described parking control in order to park the vehicle 10 in the reserved parking slot 5. Thereafter, the process proceeds to S114.

In S114, the management device 30 determines whether or not the entry of the vehicle 10 has been completed, in other words, whether or not the parking of the vehicle in the reserved parking slot 5 has been completed, using information from the infrastructure sensor 20 or the like. Consequently, when the entry is completed (S114: Yes), the process proceeds to S116.

In S116, the cloud 40 sets the status of AVP service for the vehicle 10 that has completed the entry to “waiting for entry”. Thereafter, the process proceeds to END.

### 2-2. Effect

As described above, according to the present embodiment, when the vehicle 10 compatible with AVP arrives at the getting-off area 2 of the parking lot 1 without a prior reservation regarding the use of AVP, AVP management system 100 voluntarily searches for the vacancy space of the reservation of the parking slot 5 compatible with AVP. If there is a vacancy in the appointment, AVP manager 100 notifies the user of the usage proposal of AVP via the terminal device such as HMI 12. Accordingly, when the user of the vehicle 10 that has arrived at the parking lot 1 desires to use AVP, the user does not need to perform the reservation operation including the confirmation of the vacancy of the parking slot 5 in the parking lot 1 (more specifically, the getting-off area 2). That is, the user of the vehicle 10 that has arrived at the parking lot 1 without reserving the use of AVP simplifies the operation to be performed for starting the use of AVP. Therefore, the convenience of the user with regard to the use of AVP servicing is improved.

Further, according to voluntary vacancy information search and usage proposal of the AVP management system 100 according to the present embodiment, the user can quickly reserve AVP in the getting-off area 2 as compared with the case where the user himself/herself performs the reservation operation including the confirmation of the vacancy of the parking slot 5 in the parking lot 1 (getting-off area 2). Therefore, it is possible to suppress congestion in the getting-off area 2 caused by arrival of the vehicle 10 without reservation.

Further, when the parking lot 1 on which the user has arrived is capable of both parking using AVP and parking by driving the user, the above-described usage proposal is made, and thus the following advantages can be obtained. That is, when the user has an intent to use AVP service but does not realize that AVP can be used in the parking lot 1, the user can be made aware of the availability of AVP by the usage proposal. This leads to the promotion of the use of AVP. If AVP services are provided for a fee, the profitability of AVP service providers will be improved.

### 2-3. Examples of Restrictions on Notification of Usage Proposal

As described above, the “usage proposal” according to the present embodiment leads to an improvement in convenience of the user regarding the use of AVP. On the other hand, some users may feel that receiving a notification of a usage proposal is troublesome. More specifically, for example, when the parking lot 1 on which the user has arrived is capable of both parking using AVP and parking by driving the user, it is considered that some users desire to drive the vehicle 10 and park by themselves. Therefore, the notification of the “usage proposal” may be restricted as follows.

### 2-3-1. First Embodiment

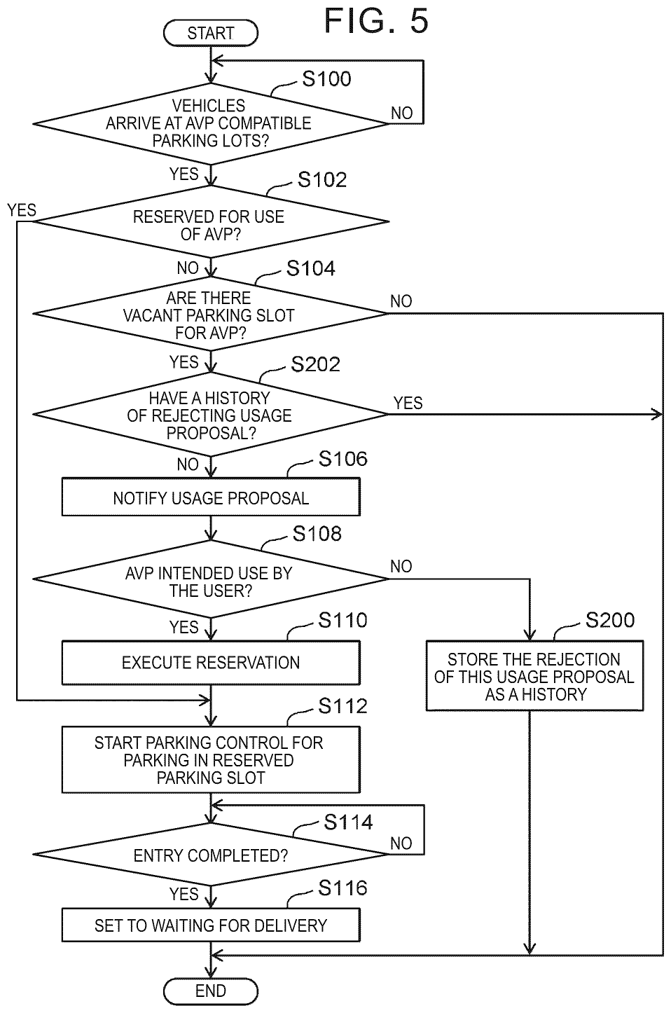

FIG. 5 is a flow chart illustrating another exemplary process performed by AVP managing device 100 according to the embodiment. This flow chart differs from the flow chart shown in FIG. 2 in that S200 and S202 processes are added.

In FIG. 5, when the user does not intend to use AVP (S108: No), that is, when an answer to reject the usage proposal is received from the user via the terminal device (for example, the user terminal 50), the process proceeds to S200. In S200, the cloud 40 stores, in the storage device 46 as a history, the rejection of the present usage proposal by the user. The rejection history is one of the above-described user information stored for each user. Thereafter, the process proceeds to END.

In addition, in FIG. 5, when there is a vacancy in the reservation of the parking slot 5 for AVP (S104: Yes), the process proceeds to S202. In S202, the cloud 40 determines, based on the user data stored in the storage device 46, whether there is a history of rejection of the usage proposal for the user who is the target of the process of the flow chart currently being executed. This determination is performed based on the user information stored in the storage device 46.

If there is no history of rejection of the usage proposal (S202: No), the process proceeds to S106 and the usage proposal is notified. On the other hand, if there is a history of rejection of the usage proposal (S202: Yes), the process proceeds to END. That is, the cloud 40 does not notify the user of the vehicle 10 who has arrived at the parking lot 1 of the usage proposal.

According to the first embodiment described above, when the vehicle 10 on which the user who has rejected the usage proposal rides arrives at the same parking lot 1 without having to reserve the use of AVP, the cloud 40 does not notify the user of the usage proposal even if the parking slot 5 for AVP is vacant. As described above, according to the first embodiment, it is possible to improve the convenience of the user with respect to the use of AVP service while giving consideration to the user who does not desire the usage proposal.

In addition, the vehicle 10 on which a user rides when using the parking lot 1 compatible with AVP is not always the same. Therefore, the restriction of the usage proposal to the user who has rejected the usage proposal may be, for example, only the vehicle 10 that was actually on board when the user has rejected the usage proposal. Alternatively, the restriction may be applied not only to the vehicle 10 that was actually on board when the user refused to make the usage proposal, but also to all the vehicles 10 on board by the user.

### 2-3-2. Second Embodiment

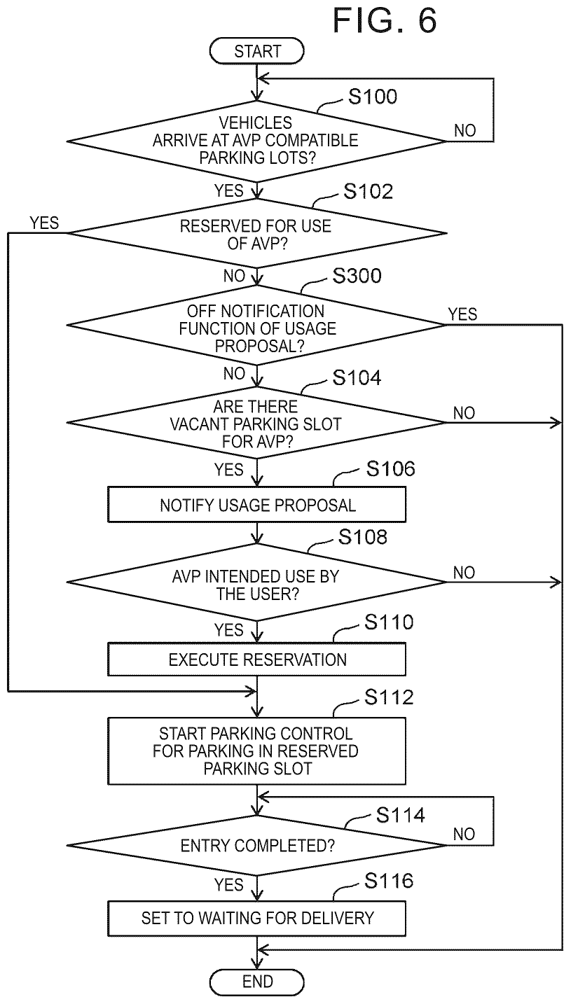

FIG. 6 is a flow chart illustrating still another exemplary process of AVP managing device 100 according to the embodiment. This flow chart is different from the flow chart shown in FIG. 2 in that S300 process is added.

In the second embodiment, the notification of the “usage proposal” has the following customization function. That is, the cloud 40 is configured such that a user who considers that the usage proposal is not necessary can set the notification function of the usage proposal to off by operating a terminal device such as a HMI 12 or the user terminal 50. In the second specific example, the user information stored in the storage device 46 of the cloud 40 includes state information indicating the state (on or off) of the notification function of the usage proposal. For example, when a user sets the notification function of the usage proposal to OFF, the cloud 40 updates the state information of the user so as to indicate that the notification function of the usage proposal is OFF.

In FIG. 6, when there is no AVP use reservation (S102: No), the process proceeds to S300. In S300, the cloud 40 determines whether the user who is the target of the process of the flow chart currently being executed has set the notification function of the usage proposal to be disabled. This determination is made based on the state information stored in the storage device 46.

When the notification function of the usage proposal is turned on (S300: Yes), the process proceeds to S104, and it is determined whether or not there is a vacancy in the parking slot 5 for AVP. On the other hand, when the notification function of the usage proposal is not set (S300: Yes), the process proceeds to END. That is, the cloud 40 does not notify the user of the vehicle 10 that has arrived at the parking lot 1 of the usage proposal regardless of whether the parking slot 5 for AVP is vacant.

According to the second specific example described above, when the user turns off the notification function of the usage proposal, that is, when a request indicating that the notification of the usage proposal is unnecessary is received in advance from the user via the terminal device (for example, the user terminal 50), the cloud 40 restricts the notification of the usage proposal as follows. That is, the cloud 40 does not notify the user of the usage proposal when the vehicle 10 on which the user boards arrives at the getting-off area 2 of the parking lot 1 without the use reservation of AVP for all the parking lots 1 that provide AVP service by AVP management system 100. As described above, according to the second embodiment, it is possible to improve the convenience of the user with respect to the use of AVP service while giving consideration to the user who does not desire the usage proposal.

In addition, the vehicle 10 on which a user rides when using the parking lot 1 compatible with AVP is not always the same. Therefore, the restriction of the usage proposal for the user who sets the notification function of the usage proposal to be off may be, for example, for all vehicles 10 on which the user is on board. Alternatively, the restriction may be directed to the vehicle 10 designated by the user.

What is claimed is:

1. An automated valet parking management system for managing automated valet parking in a parking lot, the automated valet parking management system comprising:
one or more processors, wherein the one or more processors are configured to
determine, when a vehicle that is compatible with the automated valet parking arrives at the parking lot, whether a usage reservation for the automated valet parking is made by the vehicle,
search for vacancy information for reservation of a parking slot in the parking lot, when no usage reservation is made, and
when the parking slot is vacant with respect to reservation, notify a user of the vehicle regarding a usage proposal of the automated valet parking, via a terminal device operated by the user.

2. The automated valet parking management system according to claim 1, wherein the usage proposal includes information indicating a vacancy in reservation for the parking slot, and information regarding confirmation of whether the user intends to use the automated valet parking.

3. The automated valet parking management system according to claim 1, wherein when a reply rejecting the usage proposal is received from the user via the terminal device, the one or more processors do not notify the user of the usage proposal, even when the vehicle, in which the user that rejected the usage proposal is riding, arrives at the same parking lot with no usage reservation for the automated valet parking again.

4. The automated valet parking management system according to claim 1, wherein when a request indicating that notification of the usage proposal is unnecessary is received from the user via the terminal device in advance, the one or more processors do not notify the user of the usage proposal when the vehicle, in which the user is riding, arrives at the parking lot with no usage reservation for the automated valet parking, with respect to all parking lots that provide an automated valet parking service by the automated valet parking management system.
